(19) United States
(12) Patent Application Publication
(10) Pub. No.: US 2026/0126072 A1
(43) Pub. Date: May 7, 2026

(54) PIVOTABLE FURNITURE DOWEL

(71) Applicant: Julius Blum GmbH, Hoechst (AT)

(72) Inventor: Karl BALIKO, Meiningen (AT)

(21) Appl. No.: 19/434,625

(22) Filed: Dec. 29, 2025

Related U.S. Application Data
(63) Continuation of application No. PCT/AT2024/060256, filed on Jun. 28, 2024.

(30) Foreign Application Priority Data
Jul. 2, 2023 (AT) A 60114/2023
Jun. 25, 2024 (AT) A 50517/2024

(51) Int. Cl. F16B 12/20; A47B 47/04; A47B 88/90

(52) U.S. Cl. CPC F16B 12/2027; A47B 47/042; A47B 88/941; A47B 2230/0033; A47B 2230/0037; F16B 2012/209

(57) ABSTRACT

A pivotable furniture dowel for connecting furniture parts, for example for connecting wood-based panels at right angles, includes a dowel bolt. The dowel bolt is configured such that it generates different peripheral pressure forces in a receiving drilled hole of one of the furniture parts at a predetermined angle of rotation of the furniture dowel relative to the furniture parts to be connected.

The present application is a continuation of International Application PCT/AT2024/060256 filed on June 28, 2024. Thus, all of the subject matter of International Application PCT/AT2024/060256 is incorporated herein by reference.

### BACKGROUND OF THE INVENTION

The invention relates to a pivotable furniture dowel for connecting furniture parts, for example for connecting wood-based panels at right angles, wherein the furniture dowel includes at least one dowel bolt. The invention further relates to an arrangement comprising at least one pivotable furniture dowel and a first furniture part, preferably in the form of a drawer side, wherein the furniture dowel includes at least one dowel bolt. Finally, the invention relates to a method for connecting a first furniture part, preferably in the form of a drawer side, with a second furniture part, preferably in the form of a drawer bottom, by means of at least one pivotable furniture dowel.

A large number of furniture connectors are known and widely used. Simple plug-in connections with wooden dowels inserted into drilled holes are ubiquitous. As a first step, the dowel is usually glued into a face hole of a plate. A key advantage is that the dowel does not protrude beyond the surface of the panel, thus only slightly increasing the component length in terms of packaging. Therefore, the dowel may already be inserted when the furniture parts are delivered disassembled. There is no need to add the loose connecting parts.

In the field of self-assembly furniture, screwed-in bolts with ball heads which are held by eccentric cups are very common. For angled connections of the plates, the bolt is preferably screwed into the surface of the first plate. The second plate has a face hole for the bolt and an associated surface hole for the eccentric cup. In its preassembled state, the bolt protrudes beyond the surface of the plate. This is extremely inconvenient from a packaging perspective. Therefore, the bolts are usually included without being inserted. Therefore, this preparatory work must be carried out by the furniture installer. If items of furniture are to be assembled by the end customer, it is a considerable effort to teach him or her the correct assembly and the positioning of all bolts.

Another disadvantage of furniture dowels known from the prior art is that, when they are used in conjunction with furniture parts, in particular with those shaped like panels, there is a risk that the furniture parts will be damaged in a direction of thin material coverage, and that the furniture dowels will subsequently lose their hold.

### SUMMARY OF THE INVENTION

It is an object of the present invention to at least partially eliminate the disadvantages known from the prior art and, according to a first aspect of the invention, to provide an improved pivotable furniture dowel which is characterized, in particular, by minimizing the risk of damage to a furniture part in the direction of thin material coverage. Furthermore, according to a second aspect of the invention, an improved arrangement with at least one pivotable furniture dowel and a first furniture part is to be specified, which arrangement is characterized, in particular, by the fact that the assembly effort is low and at the same time a packaging size that is as small as possible can be achieved. Finally, an improved method for connecting a first furniture part to a second furniture part using at least one pivotable furniture dowel is to be specified, compared to the state of the art.

According to a first aspect, the invention thus provides a pivotable furniture dowel for connecting furniture parts, for example for connecting wood-based panels at right angles, wherein the furniture dowel includes at least one dowel bolt. The dowel bolt is designed such that it generates different peripheral pressure forces in a receiving drilled hole of one of the furniture parts at a predetermined rotation angle of the furniture dowel relative to the furniture parts to be connected.

In this way, it is possible, for example in the case of a plate-shaped furniture part, to design the dowel bolt such that it generates high peripheral pressure forces in a direction along the plane of the furniture panel, and reduced peripheral pressure forces in a direction perpendicular to the plane of the furniture panel, that is, in a direction with a thin material coverage, thereby reducing the risk of damage.

According to an advantageous embodiment of the furniture dowel, the dimension of the dowel bolt can be larger in a first direction than in a second direction.

In this context, it has proven advantageous that the dowel bolt has a longitudinal axis and that the first direction and the second direction are perpendicular to each other and each is perpendicular to the longitudinal axis.

Alternatively or additionally, the dowel bolt can have a substantially oval or an elliptical cross section.

The dowel bolt can have at least one pressure reduction groove, preferably wherein the pressure reduction groove runs in the longitudinal direction of the dowel bolt.

These measures, individually or in combination, allow for the creation of different peripheral pressure forces in a receiving drilled hole of one of the furniture parts in a technically simple manner.

There is an enormous variety of furniture panels in circulation. Their differences in terms of technical parameters such as hardness or density are equally enormous. From an economic point of view, it is desirable to connect as many different panels as possible as firmly as possible using one variety of dowel. This is achieved at least partially by providing the dowel with a pressure reduction groove which limits the clamping forces upwards.

It is advantageous for the dowel bolt to have a dowel bolt extension, preferably tapered in cross section and/or substantially circular. This design makes it easier to insert the dowel bolt into a drilled hole.

It has proven advantageous that the furniture dowel has at least one pivot pin for pivotally supporting in and/or on a first furniture part. This allows the furniture dowel to be pivotally supported in and/or on the furniture part in a simple and reliable manner.

Alternatively or additionally, the furniture dowel can include at least one fastening device for clampingly fastening the furniture dowel in and/or on a first furniture part. In this context, it has proven advantageous that the fastening device includes a tension rod and at least one clamping surface which can be expanded outwards over it. The clamping surface is expanded outwards minimally at a predetermined angle of rotation between the tension rod and the dowel bolt of more than 90° and less than 180°, preferably in a predetermined angle of rotation of approximately 100°, preferably wherein the clamping surface is expanded outwards maximally at a predetermined angle of rotation of approximately 180°.

The dowel bolt can also be rotatably supported on the fastening device, preferably wherein the dowel bolt has at least one displacement contour which is mounted in a slot of the fastening device, wherein the slot can be widened when the dowel bolt is rotated by means of the at least one displacement contour, and/or a top side of the fastening device and a top side of the dowel bolt can be arranged in a common plane at a predetermined angle of rotation between the fastening device and the dowel bolt of approximately 90°.

According to a second aspect of the invention, an arrangement is provided having at least one pivotable furniture dowel and a first furniture part, preferably in the form of a drawer side, wherein the furniture dowel includes at least one dowel bolt. The furniture dowel is rotatably mounted in a first furniture part in a resting state, preferably about a pivot axis extending transversely to a longitudinal axis of the dowel bolt, and the dowel bolt, in the resting state of the furniture dowel, is arranged within an outer shell of the first furniture part, that is, it does not protrude beyond the outer shell of the first furniture part.

This reduces the assembly effort, since it is clear to the installer where to use the furniture dowel. On the other hand, the first furniture part, including the furniture dowel, can be packed in a particularly space-saving manner, since the dowel bolt is located inside the outer shell of the first furniture part in the resting state, which corresponds to its transport or shipping state.

According to an advantageous embodiment of the arrangement, the dowel bolt protrudes vertically from one of the outer surfaces of the first furniture part in a working state.

In this context, it has proven advantageous that the arrangement comprises at least one second furniture part, preferably in the form of a drawer bottom. The second furniture part has at least one drilled hole in which the dowel bolt arranged in the working state is at least partially received. Additionally, the second furniture part can have layer planes that run substantially parallel to an outer surface of the second furniture part, and the dimension of the dowel bolt in a first direction parallel to the layer planes is larger than in a second direction perpendicular to the layer planes, such that higher peripheral pressure forces can be generated along the first direction than along the second direction.

A more detailed explanation of an advantageous embodiment of the invention can be given by referring to the connection of a drawer side frame with a drawer bottom. In modern drawer systems, these parts are delivered individually and loose to the furniture manufacturer, usually even by different suppliers. High packing density is an absolute must. Additional loose assembly components are undesirable. If the first furniture part is designed as a panel, the pivotable dowel can be flush with the panel in its resting state, for example. When assembling with a second furniture part, also designed as a panel, for example, the dowel is rotated 90 degrees such that it protrudes vertically from the surface of the first panel. The second plate has a drilled hole for receiving the dowel bolt. Driving the dowel bolt into the corresponding drilled hole can be done, for example, using pressing devices or, in a very simple case, using a hammer.

Furniture panels can be described as homogeneous materials. But in almost all cases, they are structured in layers. This results in very different splitting behavior, depending on the direction of the layers. If, in an MDF board, a dowel is pressed perpendicular to the surface into a hole having a too small diameter, the force required to pull out the dowel is very high, even without gluing. A considerable diameter difference can be chosen perpendicular to the plate layers, thus achieving high surface pressure in the hole without destroying the plate. However, if the cylinder axis of the dowel bolt is parallel to the layer planes, the layers will split even with small diameter differences.

If the pivotable dowel rotates about an axis that is arranged transversely to the bolt axis, the dowel bolt is arranged at a defined angle of rotation. If the dowel bolt is designed as a rod with an oval or elliptical end face, it generates different pressure forces in right-angled directions of action in the circular hole, depending on the angle of rotation. If, in the case of a bolt with an elliptical cross section, the distance between the focal points of the elliptical bolt is laid parallel to the layer planes, the bolt develops very low pressure forces in the drilled hole perpendicular to the layer planes but very high pressure forces along the plate layer planes.

Despite high surface pressures in the hole, this prevents the plate from splitting. The difference in forces is proportional to the distance between the focal points. Even without gluing the bolts in place, considerable pull-out forces are required to loosen the connection. Harpoon-like ribs along the bolt jacket can provide additional retention against the connection separating. Alternatively or additionally, it may be useful to extend the bolt at its insertion end with a circular pin, which in turn is chamfered or rounded at its end. This greatly simplifies the insertion of the dowel bolt into the drilled hole.

It has proven advantageous that at least one receiving contour is recessed in the first furniture part, into which the dowel bolt is inserted in the resting state, and/or wherein the furniture dowel has at least one pivot pin over which the furniture dowel is pivotably mounted in and/or on the first furniture part.

The pivot dowel can also be reduced in size along the pivot pin by circular segments. Therefore, insertion into the receiving contour is only possible at a specific pivot angle. If the dowel is then pivoted into its resting position, undesired falling out is prevented.

Another characteristic of typical dowel joints is that the drilled holes which each hold the dowel on one side are concentric in the state of use. In the case of connecting a drawer side panel to a drawer bottom, it can be advantageous for the dowel joint to have a tolerance range in one direction. Along the drawer bottom groove, the dowel which protrudes vertically in the working position should center with as little play as possible, such that, in the working state of all components, the front edge of the bottom is flush with the end face of the drawer side. In this specific application, a tolerance path along the pivot axis of the dowel is very useful so that the bottom can be better inserted into the groove that is chamfered at the bottom. This function is required if the bottoms to be inserted are not perfectly flat. The same dowel can be used with or without this tolerance path. The parameters for this are determined by the shape of the receiving contour, which also includes the pivot axis. The opposite hole of the second component is preferably circular and thus corresponds to a cylindrical bore. Excess drilling depth has no direct impact on the function of the connection.

In the event that the furniture dowel has at least one fastening device for clamping the furniture dowel in and/or on the first furniture part, it has proven advantageous for the fastening device to have a tension rod and at least one clamping surface that can be expanded outwards above it. The clamping surface is expanded outwards minimally at a predetermined angle of rotation between the tension rod and the dowel bolt of more than 90° and less than 180°, preferably at a predetermined angle of rotation of approximately 100°, and in this position assumes a fastening state in which the furniture dowel can be fastened in and/or on the first furniture part by the fastening device. Preferably, the clamping surface is expanded outwards maximally at a predetermined angle of rotation of approximately 180°, which corresponds to the working state.

As stated at the outset, protection is also sought for a method for connecting a first furniture part, preferably in the form of a drawer side, with a second furniture part, preferably in the form of a drawer bottom, by at least one pivotable furniture dowel according to the invention. The method includes the following method steps: the furniture dowel is arranged at a predetermined angle of rotation relative to the furniture parts to be connected, the dowel bolt is received at least partially in a drilled hole of one of the furniture parts, and the dowel bolt generates different peripheral pressure forces in the drilled hole.

According to an advantageous embodiment of the method, in a first process step, the furniture dowel is attached to the first furniture part and/or pivoted from a resting state in which the dowel bolt is arranged within an outer shell of the first furniture part, that is, does not protrude beyond the outer shell of the first furniture part, into a working state in which the dowel bolt protrudes perpendicularly from one of the outer surfaces of the first furniture part, and in the working state is received at least partially in the drilled hole of one of the furniture parts.

In this context, it has proven advantageous to attach the furniture dowel to the first furniture part in a fastening state different from the resting state and/or working state.

### BRIEF DESCRIPTION OF THE DRAWINGS

Further details and advantages of the invention will be explained in more detail hereinafter with reference to the drawings, in which:

FIG. 1 is a perspective view of an arrangement with a pivotable furniture dowel and a first furniture part in the form of a drawer side, wherein the dowel bolt of the furniture dowel is arranged in a resting state,

FIG. 2 shows the arrangement according to FIG. 1, wherein the dowel bolt is arranged in a working state, and wherein a second furniture part in the form of a drawer bottom is provided,

FIG. 3 is a perspective view of an arrangement with a pivotable furniture dowel and a second furniture part, wherein the dowel bolt of the furniture dowel is arranged in a working state,

FIG. 3a shows the arrangement according to FIG. 2, wherein the furniture dowel is not yet fastened to the first furniture part,

FIG. 4 is a perspective view of a furniture dowel according to a first exemplary embodiment,

FIGS. 4a, b are further perspective views of the furniture dowel according to FIG. 4,

FIG. 5 is a perspective view of a furniture dowel according to a second exemplary embodiment, wherein the dowel bolt of the furniture dowel is arranged in a working state,

FIG. 6 shows the furniture dowel according to FIG. 5, wherein the dowel bolt is arranged in a resting state,

FIG. 7 shows the furniture dowel according to FIG. 5, wherein the dowel bolt is arranged in a fastening state,

FIGS. 7a, b are sectional views of the furniture dowel according to FIG. 7 in a perspective view (FIG. 7a)) and in a side view (FIG. 7b)),

FIGS. 8, 8a are a perspective view (FIG. 8) and an exploded view (FIG. 8a) of a furniture dowel according to a third exemplary embodiment, and

FIG. 8b shows the furniture dowel according to FIGS. 8 and 8a), wherein the furniture dowel is arranged on a first furniture part.

### DETAILED DESCRIPTION OF THE INVENTION

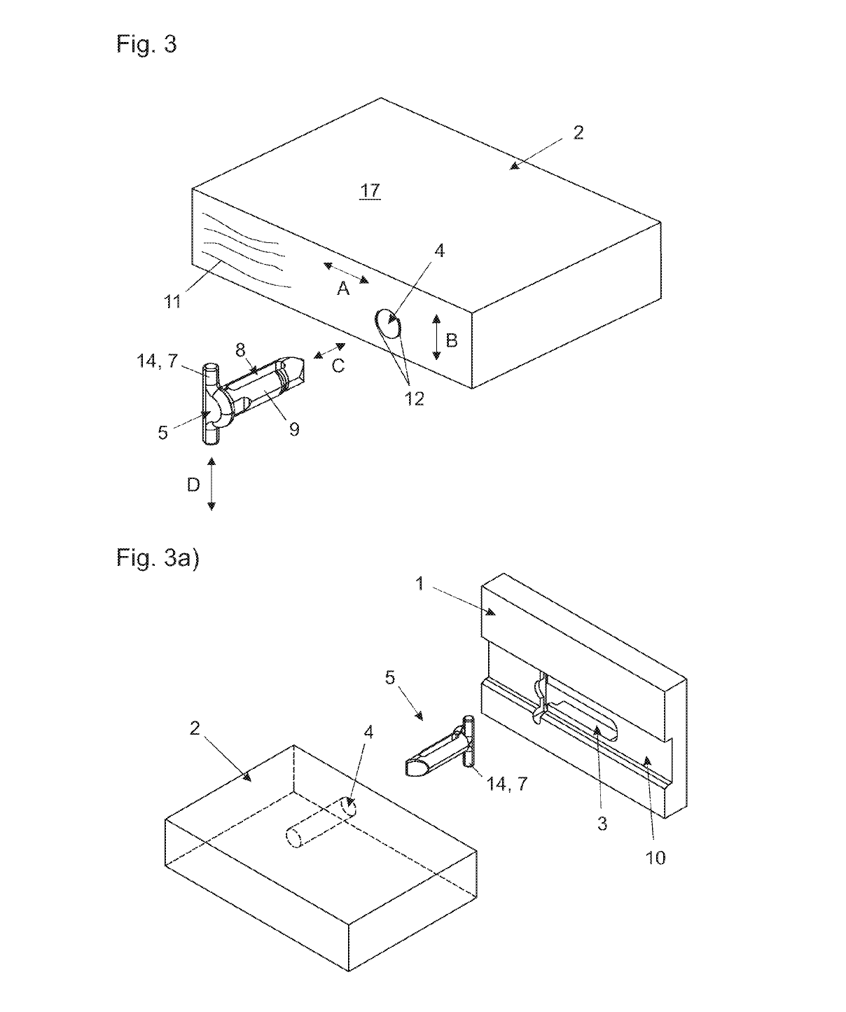

FIG. 1 shows an arrangement having at least one pivotable furniture dowel 5 and a first furniture part 1 in the form of a drawer side, wherein the furniture dowel 5 has at least one dowel bolt 9. The furniture dowel 5 is in a resting state and is preassembled in the first furniture part 1 for rotation about a pivot axis D transverse to a longitudinal axis C of the dowel bolt 9 (see also FIG. 3). The dowel bolt 9 is arranged within an outer shell of the first furniture part 1 in the resting state of the furniture dowel 5, that is, it does not protrude beyond the outer shell of the first furniture part 1.

A receiving contour 3 is recessed in the drawer side 1. A pivot dowel 5 in its resting position is inserted into this receiving contour 3, such that its dowel bolt 9 does not protrude beyond the outer shell of the furniture part. A bottom groove 10 can be provided to accommodate the edge of a drawer bottom.

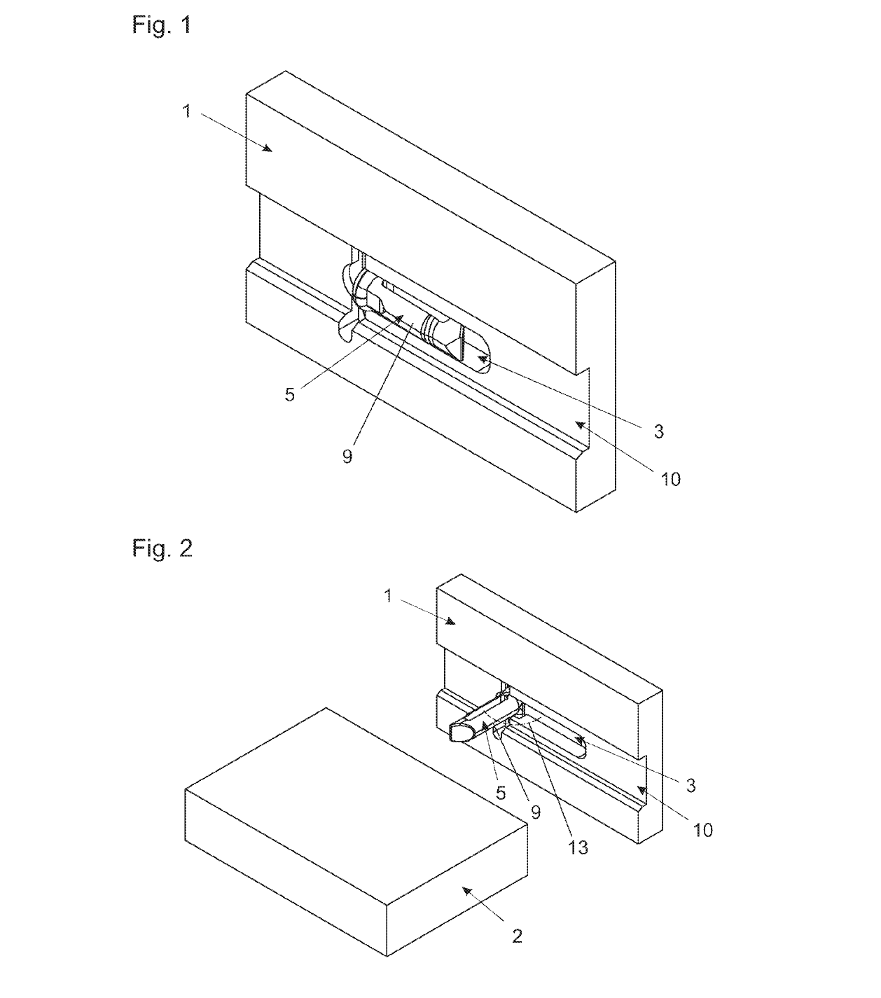

FIG. 2 shows the arrangement according to FIG. 1, wherein the dowel bolt 9 is arranged in a working state, and wherein a second furniture part 2 in the form of a drawer bottom is provided.

In its working state, the dowel bolt 9 protrudes vertically from one of the outer surfaces of the first furniture part 1. In the case of a drawer side, the outer surface of the first furniture part 1 forms an inner surface of a drawer.

The second furniture part 2 has at least one drilled hole 4 into which the dowel bolt 9, arranged in the working state, can be received at least partially. For this purpose, the two furniture parts 1, 2 are moved in a direction parallel to a longitudinal axis C of the dowel bolt 9 relative to each other.

The angle of rotation of the furniture dowel 5 is indicated by the reference symbol 13.

FIG. 3 shows an arrangement with a pivotable furniture dowel 5 and a second furniture part 2, wherein the dowel bolt 9 of the furniture dowel 5 is arranged in the working state.

The furniture dowel 5 is used for connecting furniture parts 1, 2, for example for connecting wood-based panels at right angles, wherein the furniture dowel 5 has at least one dowel bolt 9, and wherein the dowel bolt 9 is designed such that it generates different peripheral pressure forces in a receiving drilled hole 4 of one of the furniture parts 1, 2 (see FIG. 2) at a predetermined angle of rotation 13 the furniture dowel 5 relative to the furniture parts 1, 2 to be connected.

The dimension of the dowel bolt 9 is larger in a first direction A than in a second direction B.

The dowel bolt 9 has a longitudinal axis C, which can also be named the dowel bolt axis, and the first direction A and the second direction B are perpendicular to each other and each is perpendicular to the longitudinal axis C.

The dowel bolt 9 has a substantially oval or an elliptical cross section.

The second furniture part 2 has layer planes 11, which can also be named plate planes, that run substantially parallel to an outer surface 17 of the second furniture part 2, and the dimension of the dowel bolt 9 in a first direction A parallel to the layer planes 11 is larger than in a second direction B perpendicular to the layer planes 11, such that greater peripheral pressure forces can be generated along the first direction A, namely in the zones 12, than along the second direction B.

FIG. 3 shows the layer planes 11 of the furniture panel, which planes run parallel to the outer surface 17. The first direction A is also parallel to these layer planes 11 and simultaneously perpendicular to the direction B and also perpendicular to the dowel bolt axis C. The oval dowel bolt 9, aligned at its angle of rotation 13, is wider in the first direction A than in the second direction B. Thus, increased peripheral pressure forces are generated along the plate planes 11 in the zones 12, while no or hardly any peripheral pressure forces act in the second direction B. The representation of the pivot pin 7 is used for orientation. Its mounting determines the angle of rotation 13 of the oval dowel bolt 9.

FIG. 3a) shows the arrangement according to FIG. 2, wherein the furniture dowel is not yet fastened to the first furniture part 1.

The furniture dowel 5 has at least one pivot pin 7 for pivotally supporting in and/or on a first furniture part 1.

In this embodiment, the pivot pin 7 represents a fastening device 14 for clamping the furniture dowel 5 in and/or on a first furniture part 1.

In the first furniture part 1, at least one receiving contour 3 is recessed into which the dowel bolt 9 is inserted in the resting state.

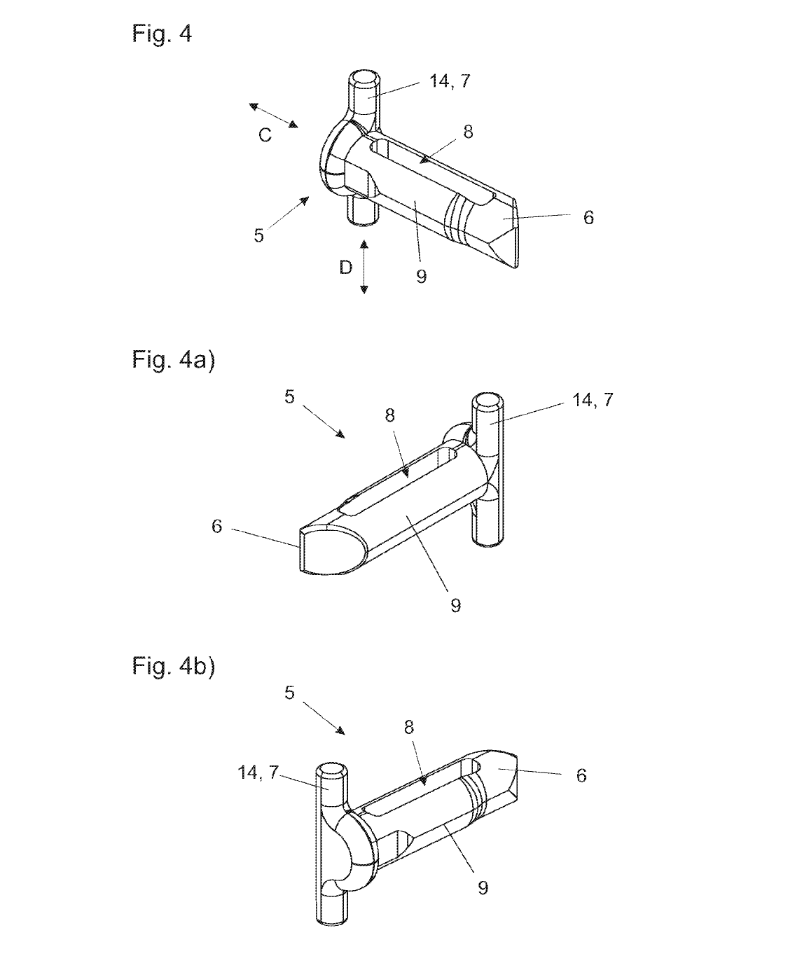

As can be seen in particular from FIG. 4, the dowel bolt 9 has at least one pressure reduction groove 8 and a dowel bolt extension 6, preferably tapered in cross section and/or substantially circular.

The pressure reduction groove 8 ensures that the driving forces do not become too great in very dense plate materials. Also shown is the circular dowel bolt extension 6 with its rounding. Furthermore shown are the pivot axis D and the dowel bolt axis C, which runs at right angles thereto and is identical to the drilling axis in the second furniture part 2.

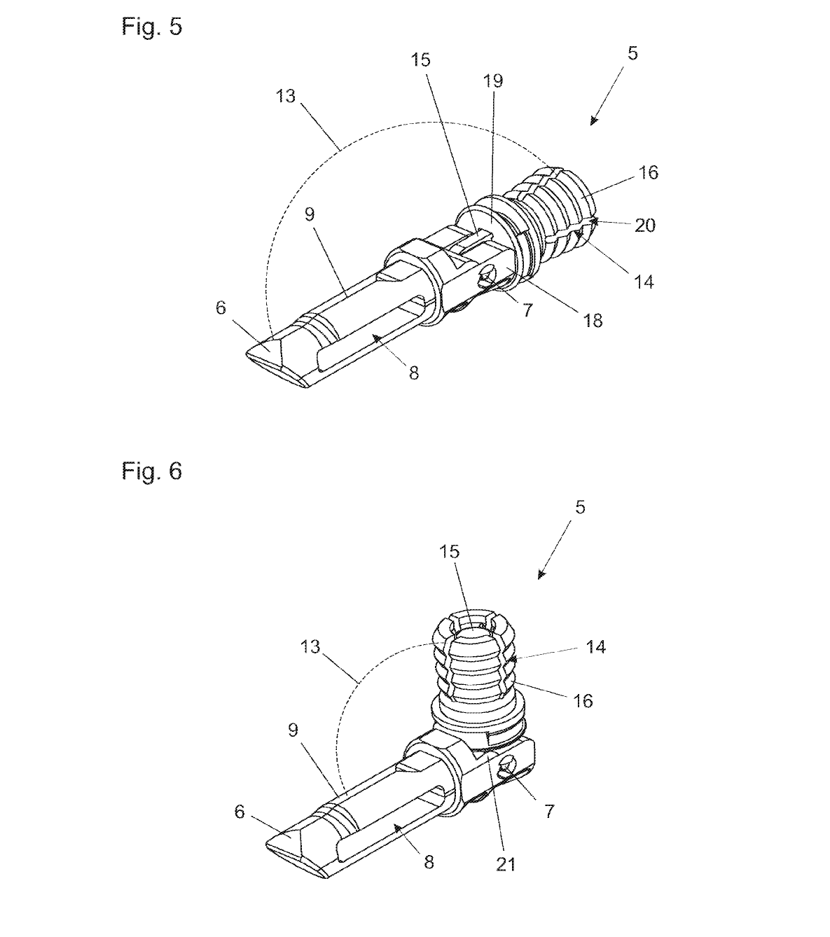

FIG. 5 shows a furniture dowel 5 according to a second exemplary embodiment, wherein the dowel bolt 9 of the furniture dowel 5 is arranged in a working state.

The furniture dowel 5 has at least one fastening device 14 for fastening the furniture dowel 5 in and/or on a first furniture part 1.

The fastening device 14 has a tension rod 15 and at least one clamping surface 16 which can be expanded outwards thereover, wherein the clamping surface 16 is expanded outwards minimally at a predetermined angle of rotation 13 between the tension rod 15 and the dowel bolt 9 of more than 90° and less than 180°, preferably at a predetermined angle of rotation 13 of approximately 100°, preferably wherein the clamping surface 16 is expanded outwards maximally at a predetermined angle of rotation 13 of approximately 180°.

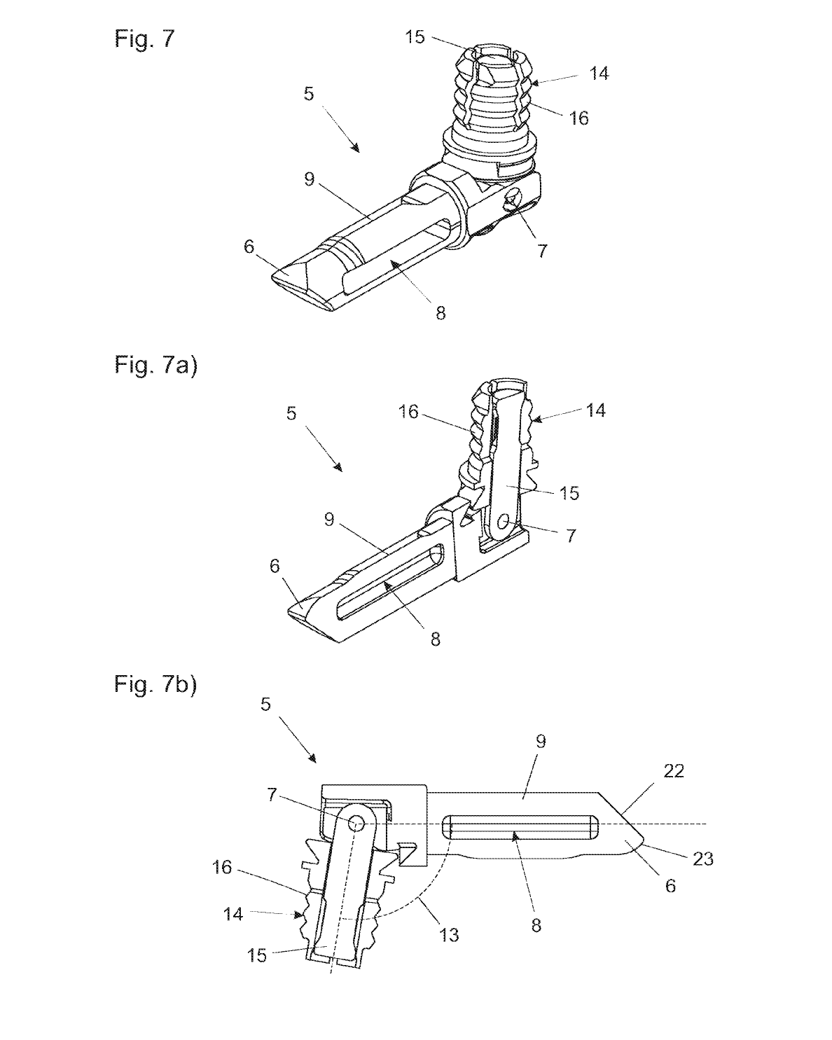

The tension rod 15 is arranged in three positions relative to the clamping surface 16, namely in a working state with a maximum spread (FIG. 5), in a resting state with a slight spread (FIG. 6), and in a fastening state with a minimum spread (FIGS. 7, 7a and 7b).

Multiple clamping surfaces 16 can be provided, which can be spaced apart from each other by slots 20, as in the case shown.

To achieve the maximum spreading effect in the working state, the clamping surfaces 16, which are movable relative to the tension rod 5, are supported on the dowel bolt 9 via a bearing 18 and an abutment 19, which can be plate-shaped, for example.

FIG. 6 shows the dowel 5 in its resting state, which corresponds to a transport position or preassembly position in which the furniture parts are transported loosely with the preassembled connecting fitting. In this position, the tension rod 15 is only very slightly pulled into the fastening device 14 by another bearing 21, which can be in the form of a small step on the dowel bolt 9, for example. This causes the clamping surface 16 to become slightly jammed in the furniture part.

FIG. 7 shows the dowel 5 in its fastening state, in which the clamping surface 16 is spread outwards at a predetermined angle of rotation 13 between the tension rod 15 and the dowel bolt 9 of more than 90° and less than 180°, preferably at a predetermined angle of rotation 13 of approximately 100°. The tension rod 15 is in the outermost position and the fastening device 14, which in this embodiment can also be referred to as an expansion dowel, is completely relieved, that is, no expansion takes place. In this position, the furniture dowel 5 can be attached to and/or on the first furniture part 1 by means of the fastening device 14. The furniture dowel 5 is thus fastened to the first furniture part 1 in a fastening state different from the resting state and/or working state.

To facilitate the insertion of the dowel bolt 9 into a drilled hole 4, as shown in the illustrated exemplary embodiments, the dowel bolt 9 can have a dowel bolt extension 6 on which an inclined surface 22 and, if necessary, a further inclined surface 23 is arranged.

A method for connecting a first furniture part 1, preferably in the form of a drawer side, with a second furniture part 2, preferably in the form of a drawer bottom, can be designed by at least one of the pivotable furniture dowels 5 described above, in that the method comprises the following method steps: the furniture dowel 5 is arranged at a predetermined angle of rotation 13 relative to the furniture parts 1, 2 to be connected, the dowel bolt 9 is received at least partially in a drilled hole 4 of one of the furniture parts 1, 2, and the dowel bolt 9 generates different peripheral pressure forces in the drilled hole 4.

In a first method step, the furniture dowel 5 is fastened to the first furniture part 1 and/or pivoted from a resting state in which the dowel bolt 9 is arranged within an outer shell of the first furniture part 1, that is, does not protrude beyond the outer shell of the first furniture part 1, into a working state in which the dowel bolt 9 protrudes perpendicularly from one of the outer surfaces of the first furniture part 1, and in the working state is received at least partially in the drilled hole 4 of one of the furniture parts 1, 2.

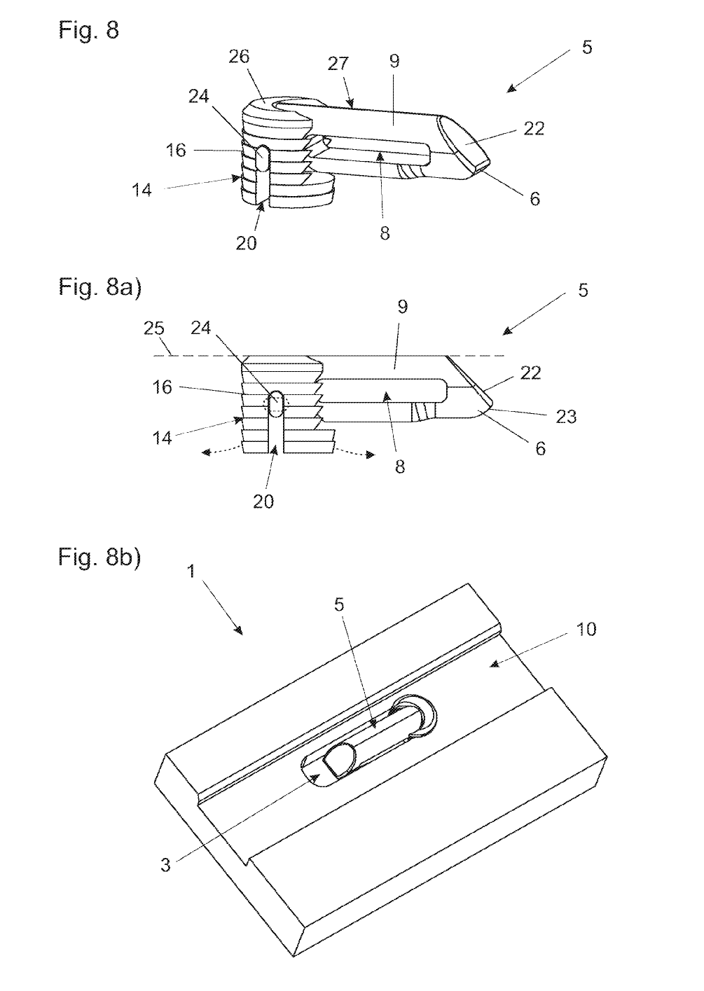

FIGS. 8, 8a and 8b show a furniture dowel 5 according to a third exemplary embodiment. The dowel bolt 9 is rotatably mounted on the fastening device 14, wherein the dowel bolt 9 has at least one displacement contour 24 which is mounted in a slot 20 of the fastening device 14, wherein the slot 20 can be widened when the dowel bolt 9 is rotated by means of the at least one displacement contour 24. In a first position, the displacement contour 24 is arranged in the slot 20 such that the contour has substantially the width of the slot 20. In a second position (shown with dashed lines in FIG. 8a), the displacement contour 24 is arranged in the slot 20 such that it has a second width that differs from the first and is larger than the width of the slot 20. This can be achieved, for example, by a shape of the displacement contour 24 that deviates from a circular shape, such as an oval shape.

In this exemplary embodiment, the displacement contour 24 represents a pivot bearing for the rotatable connection between fastening device 14 and dowel bolt 9.

Advantageously, a top surface 26 of the fastening device 14 and a top surface 27 of the dowel bolt 9 can be arranged in a common plane 25 at a predetermined angle of rotation 13 of approximately 90° between the fastening device 14 and the dowel bolt 9. In this way, the furniture dowel 5 is completely recessed in a furniture part, allowing multiple such furniture parts to be stacked in a space-saving manner.

1. A pivotable furniture dowel for connecting furniture parts, for example for connecting wood-based panels at right angles, comprising:
at least one dowel bolt configured such that it generates different peripheral pressure forces in a receiving drilled hole of one of the furniture parts at a predetermined angle of rotation of the furniture dowel relative to the furniture parts to be connected.

2. The pivotable furniture dowel according to claim 1, wherein the dimension of the dowel bolt is larger in a first direction than in a second direction.

3. The pivotable furniture dowel according to claim 2, wherein the dowel bolt has a longitudinal axis and the first direction and the second direction are perpendicular to each other and each is perpendicular to the longitudinal axis.

4. The pivotable furniture dowel according to claim 2, wherein the dowel bolt has a substantially oval or an elliptical cross section.

5. The pivotable furniture dowel according to claim 1, wherein the dowel bolt includes at least one pressure reduction groove and/or a dowel bolt extension which is preferably tapered in cross section and/or which is substantially circular.

6. The pivotable furniture dowel according to claim 1, wherein the furniture dowel includes at least one pivot pin for pivotally supporting in and/or on a first furniture part.

7. The pivotable furniture dowel according to claim 1, wherein the furniture dowel includes at least one fastening device for clampingly fastening the furniture dowel in and/or on a first furniture part.

8. The pivotable furniture dowel according to claim 7, wherein the fastening device includes a tension rod and at least one clamping surface which can be expanded outwards thereover, wherein the clamping surface is expanded outwards minimally at a predetermined angle of rotation between the tension rod and the dowel bolt of more than 90° and less than 180°, preferably at a predetermined angle of rotation of approximately 100°, preferably wherein the clamping surface is expanded outwards maximally at a predetermined angle of rotation of approximately 180°.

9. The pivotable furniture dowel according to claim 7, wherein the dowel bolt is rotatably supported on the fastening device, preferably wherein:
the dowel bolt includes at least one displacement contour which is mounted in a slot of the fastening device, wherein the slot can be widened when the dowel bolt is rotated by means of the at least one displacement contour, and/or
a top surface of the fastening device and a top surface of the dowel bolt can be arranged in a common plane at a predetermined angle of rotation of approximately 90° between the fastening device and the dowel bolt.

10. An arrangement comprising:
the pivotable furniture dowel according to claim 1, and
a first furniture part, preferably in the form of a drawer side, the furniture dowel including at least one dowel bolt,
wherein the furniture dowel, in a resting state, is rotatably supported in the first furniture part, preferably about a pivot axis extending transversely to a longitudinal axis of the dowel bolt, and the dowel bolt, in the resting state of the furniture dowel, is arranged within an outer shell of the first furniture part, that is to say not protruding beyond the outer shell of the first furniture part.

11. The arrangement according to claim 10, wherein the dowel bolt, in a working state, protrudes vertically from one of the outer surfaces of the first furniture part.

12. The arrangement of claim 11, wherein the arrangement comprises at least one second furniture part, preferably in the form of a drawer bottom, and wherein the second furniture part has at least one drilled hole in which the dowel bolt arranged in the working state is at least partially received.

13. The arrangement according to claim 12, wherein the second furniture part has layer planes that run substantially parallel to an outer surface of the second furniture part, and the dimension of the dowel bolt in a first direction parallel to the layer planes is larger than in a second direction perpendicular to the layer planes, such that higher peripheral pressure forces can be generated along the first direction than along the second direction.

14. The arrangement according to claim 10, wherein at least one receiving contour is recessed in the first furniture part, into which the dowel bolt is inserted in the resting state, and/or wherein the furniture dowel includes at least one pivot pin via which the furniture dowel is pivotally supported in and/or on the first furniture part.

15. The arrangement according to claim 10, wherein the furniture dowel includes at least one fastening device for clampingly fastening the furniture dowel in and/or on the first furniture part, preferably wherein the fastening device includes a tension rod and at least one clamping surface that can be expanded outwards thereover, wherein the clamping surface is expanded outwards minimally at a predetermined angle of rotation between the tension rod and the dowel bolt of more than 90° and less than 180°, preferably at a predetermined angle of rotation of approximately 100°, and in this position assumes a fastening state in which the furniture dowel can be fastened in and/or on the first furniture part by means of the fastening device, preferably wherein the clamping surface is expanded outwards maximally at a predetermined angle of rotation of approximately 180°, which corresponds to the working state.

16. A method for connecting a first furniture part, preferably in the form of a drawer side, with a second furniture part, preferably in the form of a drawer bottom, by the pivotable furniture dowel according to claim 1, the method comprising:
the furniture dowel is arranged at a predetermined angle of rotation relative to the furniture parts to be connected,
the dowel bolt is at least partially received in a drilled hole of one of the furniture parts, and
the dowel bolt generates different peripheral pressure forces in the drilled hole.

17. The method according to claim 16, wherein, in a first method step, the furniture dowel is fastened to the first furniture part and/or pivoted from a resting state in which the dowel bolt is arranged within an outer shell of the first furniture part, that is to say without protruding beyond the outer shell of the first furniture part, into a working state in which the dowel bolt protrudes perpendicularly from one of the outer surfaces of the first furniture part, and is at least partially received in the drilled hole of one of the furniture parts in the working state.

18. The method according to claim 17, wherein the furniture dowel is fastened to the first furniture part in a fastening state which is different from the resting state and/or working state.
